(19) United States
(12) Patent Application Publication
(10) Pub. No.: US 2002/0174387 A1
(43) Pub. Date: Nov. 21, 2002

(54) Stealth module for bus data analyzer

(76) Inventors: Vance Lohoff, Tempe, AZ (US); Dean Palmer, Tempe, AZ (US); Eric Vannerson, Tempe, AZ (US); Michael Vonbank, Scottsdale, AZ (US)

Correspondence Address: MOONRAY KOJIMA, BOX 627, WILLIAMSTOWN, MA, 01267, US

(21) Appl. No.: 09/855,645

(22) Filed: Mar. 29, 2001

(51) Int. Cl. G06F 11/00

(52) U.S. Cl. 714/43

(57) ABSTRACT

A stealth module is either integrated as hardware logic into or attached as an external module to a bus analyzer, wherein the module electrically and logically isolates the analyzer from the bus being tested whereby the bus being tested is not affected by the presence of the analyzer with respect to bus topology, data transmission, bus bandwidth, and power usage, and furthermore, isolation is single directional so as to allow the analyzer to capture packets on the bus being tested.

### BACKGROUND OF THE INVENTION

1. Field of Invention

This invention relates to data analysis tools for debugging and monitoring data transmission; and more particularly, to a stealth module for use with data analyzers.

2. Description of the Prior Art

Recently, consumer electronic devices and personal computers and the peripherals used therewith have become equipped with fast, standardized serial bus interfaces. One such bus offers significant improvement over prior external bus designs, and is referred to as the 1394 interface, or by the trademarks FIREWIRE and iLINK. The designation 1394 refers to the IEEE standard 1394, which standard can be found in “IEEE Standard for High Performance Serial Bus” The Institute of Electrical and Electronic Engineers, Inc, IEEE Std 1394-1995(August 1996), or 1394-2000 (February 2000), or P1394b Draft 1.00 (February 2000). Further information on the high speed serial bus can be obtained in “Information Technology-Microprocessor System-Control and Status Registers (CSR) Architecture for micro-computer buses”, IEEE, ISO/IEC 13212:1994 (October 1994) and P1212 Draft 1.0 (October 1999).

Herein, the 1394 terminology will refer to the IEEE standard of such number. The 1394 buses currently support data transfer rates of 100,200 and 400 Mbps (i.e. megabits per second) and will support rate of up to 3.2 Gbps (i.e. gigabits per second) in future variations of the technology. Also, the 1394 bus can be implemented at lower cost when compared to similar parallel and serial buses. Use of the 1394 bus is extensive because of high speed and low cost.

The 1394 bus supports both asynchronous and isochronous data transfer mechanisms. Asynchronous data transfers are for applications that require “quality of delivery”, i.e. transfer without any data corruption. Special verification mechanisms, such as CRC validation, packet acknowledgements, etc, guarantee that upon unsuccessful data reception, the initiator will retry the original transmission.

Isochronous data transfers are for applications that require “quality of service”, i.e. data delivery at a guaranteed rate. The specified and guaranteed packet transmission every 125 μs reduces buffering requirements on both the receiver and transmitter side and hence reduces cost of the system. Typical applications of isochronous data transfer mode include real time audio and video streaming.

Devices attached to the 1394 serial bus automatically participate in the bus enumeration and configuration process without requiring any intervention from the host system. The bus configuration is extremely dynamic and the bus topology can be different after every bus reset. Reset are typically initiated when devices are added or subtracted from the bus. Hence, the CSR and Configuration ROM (read only memory) architecture, as defined in the ISO/IEC 13213 (ANSI/IEEE 1212) specification and the P1212 Draft 1.0 specification, is extremely well suited to support device discovery mechanism as required in UPnP (Universal Plug and Play) and JINI. Any device can actively query any other device capability and function in order to determine communication protocols, settings, etc.

The 1394 buses can support up to 64 node addresses on a single serial bus with each of the nodes having a 256 terabyte address space. This large address space makes the 1394 bus an efficient way to bridge different host systems and multiple serial buses. In particular, a single 1394 bus is able to bridge up to 1024 serial buses.

Four functional layers are defined to simplify and organize the interaction between hardware and software. Each layer has a set of services defined to support communication between an application and the 1394 bus. These layers include (1) a bus management layer that supports bus configuration and management activities for each node; (2) a transaction layer that supports the request response protocol for read, write and lock operations related to asynchronous transfer; (3) a link layer that provides translation of a transaction layer request or response into a corresponding packet and that handles basic transmission error recovery; and (4) a physical layer that provides the electrical and mechanical interface across the serial bus, handles device enumeration and arbitration, and manages data transmission arbitration.

The bus management layer and the transaction layer are typically implemented through software, whereas the link layer and physical (often referred to as the “Phy” layer) are typically implemented through use of silicon, that is hardware. Usually, separate chips are used for the Phy and Link. The latest technology has allowed combining these two layers in one chip, hence, reducing board space requirements and costs.

The physical interface is a 6-wire (or 4-wire) cable with specified lengths and impedance characteristics. Two wires are used for power and ground connections, the other four being for data transmission. Two of the wires are pair together to form differential pairs TPA+/TPA− and TPB+/TPB−. One pair of wires is used for data transmission, and the other pair is used for strobe.

The complexity of the basic 1394 data transmission protocol and higher level protocols like SPB2, AV/C, IPv4, HAVi, unfortunately, can make the development of devices most efficiently utilizing its 1394 high speed interface a challenging task. The dynamic node numbering and topology re-enumeration which are inherently built into 1394 create their own set of difficulties and challenges. This is the reason why especially in 1394 related analysis specialized bus analyzers are requirements for all development efforts.

Data analyzers are specialized measurement devices designed to test and debug electronic systems. One type of data analyzer is used to monitor traffic along serial buses. These buses provide a transmission path on which signal are dropped off or picked up at every attached device. Bus data analyzers specifically for 1394 buses provide a wide range of diagnostic tools for testing 1394 buses. For example, 1394 bus data analyzers provide full isochronous and asynchronous data capturing capabilities making them capable measurement tools for 1394 protocol analysis, traffic monitoring and even identification. Together with timing analysis, bandwidth analysis and higher level protocol analysis, they provide the tools needed for a 1394 design team to fully implement, test and debug a bus interface implementation.

Typical analyzers have to be physically connected to the bus under test in order to capture data. This means that the bus topology of the bus under test, its signaling characteristics, and its power management are changed by the presence of an attached analyzer. In the traditional approach, the only way to capture bus data with a 1394 analyzer is to make the analyzer a part of the bus under test. The additional devices affect the bus under test. All assigned node IDs (virtual device numbers) are different, bus topologies are different and the power budget on the test bus (hereinafter called “test bus”) can be affected. In order to minimize their effects, state of the art 1394 data analyzers can be configured to be absolutely quiet, i.e. they will not generate any 1394 packets. But, the presence thereof per se, creates additional bus traffic. For example, 1394 supports dynamic device discovery. Intelligent device implementation thus will initiate service functions attempting to query all connected devices. Since traditional 1394 data analyzers are valid 1394 devices, as well, they will also be queried. When the analyzer is configured not to respond, the querying device might retry the query under the assumption that the original attempt had failed. It might continue doing this forever, or until the upper level software experiences a retry limit or generates a time out.

Thus, in the absence of an analyzer capable of performing analysis functions without itself being a part of the 1394 bus, the task of device functionality verification and device testing heretofore has been very cumbersome and difficult.

### SUMMARY OF THE INVENTION

Accordingly, an object of the invention is to overcome the aforementioned and other disadvantages, deficiencies and problems of the prior art.

Another object is to provide a data analyzer with stealth capabilities which has improved system behavior over prior art designs. The stealth capabilities allow the capturing of data and monitoring of bus events without influencing the bus under test. A stealth capable analyzer is “invisible” to the bus under test.

A further object is to provide a Phy (physical) layer of the analyzer which is isolated from the bus under test by an electronic circuit. The circuit's function is to convert regular cable transactions into signals so the analyzer's Phy interprets the signal as valid data and transmits same to the Link layer. It also can “trick” the Phy layer on the analyzer to activate the 1394 port thereof so that otherwise no data can be received. By including state of the art sensing logic, the invention is capable of capturing and analyzing bidirectional data traffic on the bus under test.

### BRIEF DESCRIPTION OF THE DRAWINGS

FIG. 1 is a block diagram depicting an illustrative embodiment of the invention encompassing a data analyzer in the form of a personal computer including a stealth module.

FIGS. 2A and 2B are schematic diagrams depicting representations of a 1394 interface and the corresponding connector pin out.

FIGS. 3A, 3B and 3C are schematic diagrams depicting representation of a data transmit (TX) and a data receive (RX) operations of a 1394 bus.

FIGS. 4A and 4B are schematic views depicting bus topology configuration on a 1394 bus with 3 interconnected 1394 devices and possible combinations of topologies.

FIGS. 5A and 5B are schematic diagrams depicting bus topology configurations on a 1394 bus and 4 interconnected 1394 devices and possible combinations of topologies.

FIG. 6 is a block diagram depicting details of the stealth module of the invention.

FIG. 7 is an isometric view depicting a portion of a data analyzer with a stealth module of the invention.

### DETAILED DESCRIPTION OF PREFERRED EMBODIMENTS

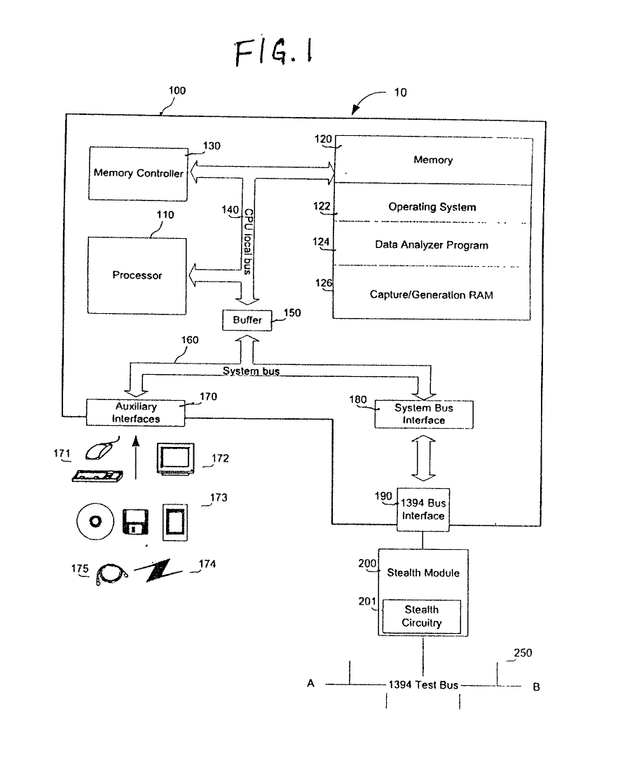

Referring to FIG. 1, a stealth capable data analyzer 10 of the invention is preferably implemented using a standard IBM compatible computer system 100. However, the invention can be implemented with any suitable capturing instrumentation, whether the capturing device is a multi-user apparatus or a single user device, such as a work station or personal computer, or a dedicated, embedded data capturing and analysis apparatus. Computer system 100 comprises a processor 110, main memory 120, a memory controller 130, a local CPU bus 140, a buffer 150, and a system bus 160. The system bus 160 interconnects the processor unit with an auxiliary interface 170 and a peripheral bus interface 180. Of course, various devices can be added to the system, such as cache memory, peripheral devices, interfaces, etc.

Processor 110 performs computation and control functions of computer system 100, and comprises a suitable central processing unit (CPU). Processor 110 may comprise a single integrated circuit, such as a microprocessor, a digital signal processor (DSP), a programmable logic device (PLD), or a field programmable gate array (FPGA), or may comprise any suitable number of integrated circuit devices and/or circuit boards working in combination to accomplish the functions of a processor. Processor 110 suitably executes computer programs within main memory 120.

Memory controller 130, through use of a processor, is responsible for moving requested or collected information from main memory 120 and/or from auxiliary interface 170 and peripheral bus interface 180 to processor 110 or vice versa. Although memory controller 130 is shown as a separate entity, portions of the function provided by memory controller 10 may reside in circuitry associated with processor 110, main memory 120 and/or auxiliary interface 170 and peripheral bus interface 180.

Memory 120 comprises an operating system 122 and a data analyzer program 124. The operating system controls the basic operations of computer system 100 and comprises any suitable operating system, such as DOS, Windows, Windows NT, OS/2 and UNIX. Computer system 100 can also be configured to work without the overhead of a full operating system.

Data analyzer program 124 preferably includes low level programs to control low level operation of the analyzer and high level programs to perform system and data analysis functions. The low level programs initialize the physical (Phy) layer and Link layer devices and control the internal registers thereof for basic capturing and data generation. Also, the low level programs handle all trigger mechanisms during data snooping and bus event monitoring, e.g. bus reset indication. When needed, the low level programs are also responsible for updating the topology map and the speed map. The high level system programs handle data management and data analysis, and provide the 1394 system services, such as bus management, isochronous resource management and cycle master functionality. Also, the high level system program provides extended system analysis features, such as control status register (CSR) and ConfigROM verification, bandwidth analysis and monitoring, device identification and scripting engines for automated and/or remote operation of the data analyzer. All the data visualization and user data input is provided either locally on computer system 100 directly or from a remote application running on another computer system. The invention also covers data visualization and remote data input via Internet connections. In this case, computer system 100 hosts a web server, which presents the captured data as html pages and/or through Java applets.

A certain portion of memory is set aside for the essential functions of data analyzer 10, which captures data on the test bus. The Capture/Generation memory 126 is reserved for storage of captured data and for data to be generated for testing purposes. The partioning of memory can be dynamic, i.e. with no fixed sizes of memory segments being assigned.

Memory 120 is used in the broadest sense and comprises dynamic random access memory (DRAM), static RAM (SRAM), flash memory, cache memory, etc. While not shown in FIG. 1, memory 120 may be a single type of memory component or may comprise many different types of memory components. Also, components of memory 120 and/or CPU 110 may be distributed across several different computers that collectively comprise system 100. The programs in memory 120 may comprise all forms of computer programs, including source codes, intermediate codes, machine codes, and any other representation of computer programs.

Some of the elements of computer system 100 are connected using local microprocessor bus 140 comprising data, address and control components. Also, coupled to the CPU is a buffer 150 which is connected to a system bus 160. The system bus 160 comprises a high speed peripheral interconnect (PCI) bus, but may also comprise other buses, such as PC104, ISA, MCA, etc. The term “PCI” includes all present and future variations of the PCI bus, such as PCI-X, Compact PCI, Serial PCI, PCI04+etc. Moreover, although computer system 100 is shown with only a single main processor 110 and a single bus 160, multiple processors and multiple buses may be used. Also, although the system bus 160 is a PCI bus, any connection device that supports bi-directional communication in a computer related environment can be used.

Auxiliary interface 170 allows computer system 100 to be coupled to a number of components forming a data analyzer 10, such as input devices, such as keyboard and mouse 171 and optional monitors 172 (such as a video monitor), attached to system 100.

Also, auxiliary interface 170 allows computer system 100 to store and retrieve information from auxiliary devices, such as magnetic disk (e.g. hard disks or floppy diskettes), optical storage devices (e.g. CD-ROM) or removable storage devices (e.g. PC cards or CompactFlash cards) 173. Although a fully functional computer system is shown implementing a data analyzer, the invention is capable of being distributed as a program product in a variety of forms, and the invention applies equally regardless of the particular type of signal bearing media to actually carry out the distribution. Examples of signal bearing media include recordable type media, such as floppy disks and CD-ROM, and transmission type media such as digital and analog wire based communication links 174 (e.g. serial buses like USP or Ethernet) and wireless communication links 175 (e.g. IRDA, Bluetooth, 802.11).

System bus interface 180 is used to connect peripheral components to the computer bus. System bus interface 180 comprises a PCI expansion bus interface that allows a plurality of PCI expansion cards to be connected to computer system 100. Other suitable interfaces can be used. In the embodiment, one bus interface 190 is connected to computer system 100 through the system bus interface. Bus interface 190 is implemented as a PCI expansion card, thereby allowing interface thereof with system bus 160 using standard PCI expansion interface.

In FIG. 1, bus interface 190 implements the bus that is to be tested and analyzed using data analyzer 10. Also, bus interface 190 implements 1394 high speed serial bus. The term “1394” includes all present and future variations of the IEEE 1394 bus, including IEEE 1394-2000, 1394.a, and P1394.b, etc.

Various auxiliary interfaces cna be used, such as keyboard/and/or mouse 171, a video input 172, a recording disk 173, and other cable and connections 174 and 175.

The embodiment of FIG. 1 comprises in addition to a regular 1394 bus interface, a stealth module 200. The term “stealth” refers to all variations of electronic circuits, components, both active and passive, and software which allows bus analyzer 10 to be invisible to test bus 250. Although the data analyzer of FIG. 1 comprises one 1394 bus interface 190, equal or better level of functionality and performance can be achieved using multiple 1394 bus interfaces 190. Two 1394 bus interfaces 190 can be interconnected using internal or external 1394 connections This allows the bus interface 190 to communicate to facilitate testing.

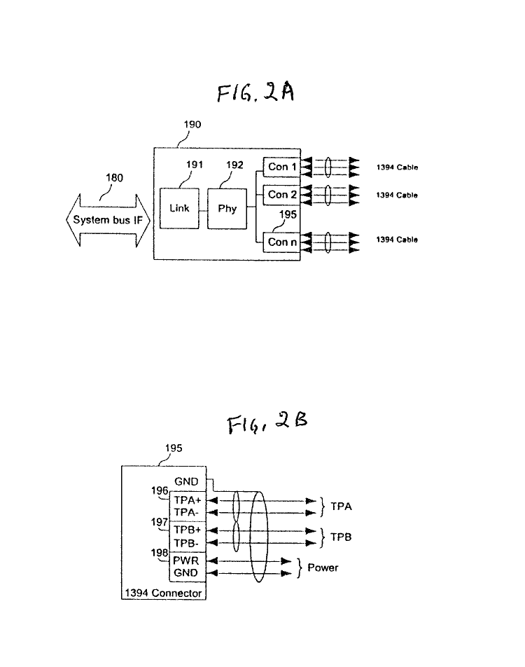

FIGS. 2A and 2B show 1394 bus interfaces comprising 4 major components, i.e. a system bus interface 190, a Link layer device 191, a Phy layer device 192. The input/output (I/O) ports of the Phy layer 192 are connected to a number of 1394 connectors 195. Although the embodiment shows the Link and Phy layers to be separate, the invention also covers bus interfaces having an integrated Phy/Link combination. As shown in FIG. 2A, the 1394 bus interface has at least one 1394 connector 195, which allows other devices to be connected to the data analyzer. The invention covers all current and future variations and combinations of 1394 connectors, including 6 pin and 4 pin connectors as well as P1394 compliant connector types. FIG. 2B shows a typical 1394 connector (of 6 pin type) with its two differential signal pairs TPA−/TPA+196; TPB−/TPB+197, and Cable Power and Cable Ground 198.

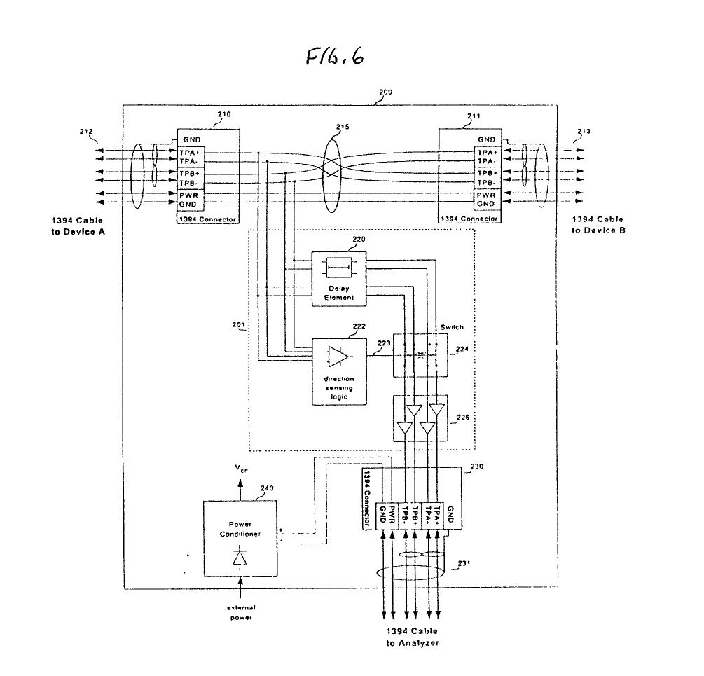

Stealth module 200 (see FIG. 1) is implemented as an add on module to basic data analyzer 10. Stealth module 200 extends the 1394 bus interface 190 by the Stealth circuitry 201 and two additional 1394 connectors 210 and 211. (see FIG. 6). The stealth module can also be integrated directly after the Phy layer 192. In such case, two 1394 bus connectors 210 and 211 replace the single 1394 bus connector 195 of a regular 1394 bus interface 190. Also, the stealth module can be implemented on one, several or all of the 1394 ports of the 1394 bus interfaces 190. The term “port” refers to the combination of one to several differential signal pairs drive by the Phy layer 192 and their respective connectors.

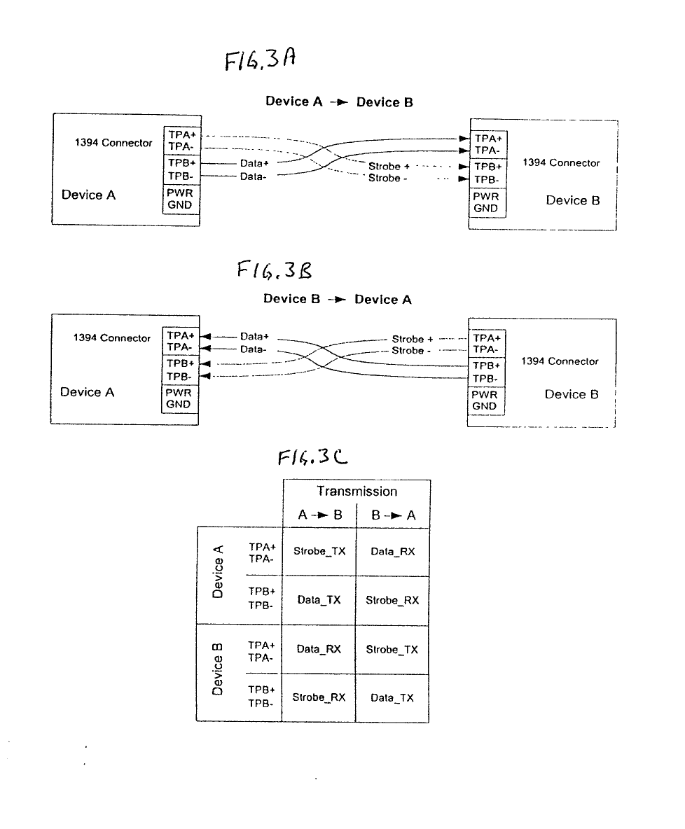

FIGS. 3A,and 3B show the relationship of differential pairs used for data or strobe transmission depending on the transmission direction. As shown in FIG. 3A, when device A is transmitting to device B (i.e. A→B) data are sent on pair TPB (A) and strobe is sent on pair TPA(A). In the cable, the wires are crossed over so that on device B data is received on TPA(B) and strobe is received on TPB(B). The letters A and B in parentheses, e.g. (A) and (B) denote that the differential pairs are observed on device A or device B. As shown in FIG. 3B, when data transmission is in the other direction (B→A) data are sent on pair TPB(B) and strobe is sent on pair TPA(B). On device A data is received on TPA(A) and strobe is received on TPB(A). The data and/or strobe transmission can also be summarized as follows: Data is always transmitted on TPB and received on TPA, and strobe is always transmitted on TPA and received on TPB. FIG. 3C shows the relationship of the device characteristics depending on transmission direction.

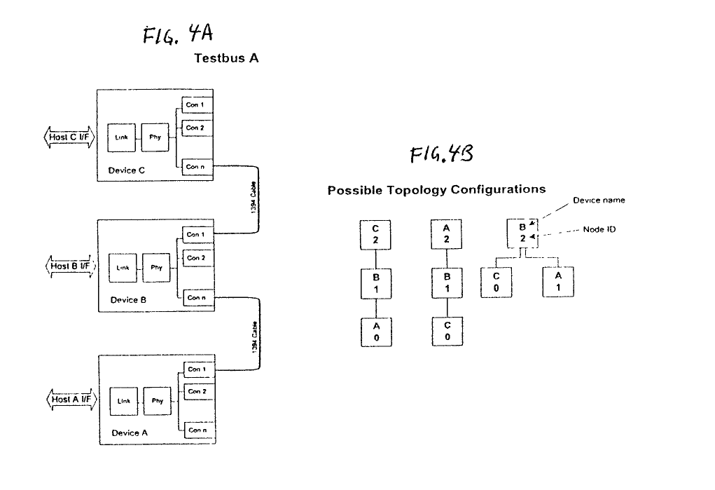

FIG. 4A displays three 1394 devices (A,B,C) connected via 1394 cables and hence form test bus A. For simplicity, only the 1394 bus interfaces are shown, but the intent is to indicate full 1394 enable devices. As shown in FIG. 4B, different possibilities exist for corresponding 1394 bus topology. During the tree arbitration period, each device is assigned a node ID, i.e. a number uniquely identifying the device on the bus. This node ID is used for addressing purposes. Any message sent to the device uses the number as part of the addressing scheme. The assigned IDs are only valid between two bus resets. After each bus reset, the bus topology can change and the enumeration can result in different node IDs for each node. From the different bus topology possibilities in FIG. 4B, it can be seen that one fixed node ID can result in an addressing of three different devices on the 1394 bus. The three different bus topologies are a consequence of small timing variations during arbitration, changing device capabilities, etc, which all result in bus rest.

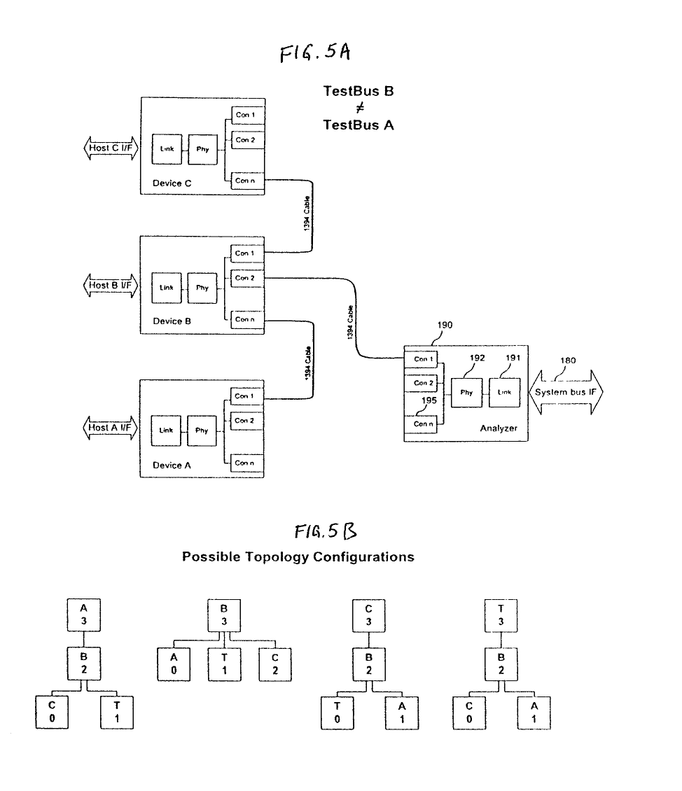

Thus, a bus reset is generated every time a device is added or removed from the bus. This happens when an analyzer is added to the test bus A. FIG. 5A shows a situation where an analyzer (represented by a 1394 bus interface 190) is connected to port 2 of a device B. This creates a bus recall. All nodes are re-arbitrated and new node IDs are assigned.

FIG. 5B shows all possibilities for bus topologies of the new bus B, which is different from bus A. First, four nodes are connected instead of three. Second, only individual devices A,B or C on test bus B have identical nodeIDs as on test bus A. But, considered as a group of devices, combined node IDs for devices A,B and C do not have a matching pair on test bus A and test bus B. only with special arrangement, i.e by connecting the analyzer to other devices, the original set of nodes and the original set of node IDs can be arranged. However, in real world situations, this arrangement proves difficult or cumbersome. For example, the device might only have one 1394 connector exposed. For many compliance and interoperability testing tasks and for debugging operations, the previously explained behavior creates severe problems. The ideal tool would be a data analyzer which is connected without a Phy layer participating in the tree arbitration process. This would result in an unchanged test bus A with its three possibilities for bus topologies. Through the open Phy port transmission data can be received on test bus A. However, regular 1394 physical layer silicon is built for other purposes and does not really support the requirements. The Phy ports stay closed until they believe that they are properly connected to a child or parent port, and open ports will automatically participate in the arbitration. The invention provides a solution to the aforementioned problem. Standard 1394 Phy layer devices can be “fooled” into the desired mode.

In FIG. 6, stealth module 200 is inserted between device A and device B on the test bus 250 (see FIG. 1). Two cables connected to standard 1394 connectors 210 and 211 allow the device to be easily connected to devices A and B on the test bus 250. The connection 215 between connector 210 and 211 is a transmission line cross over pass through element (TPA→TPB, TPB→TPA, PWR/GRND→PWR/GRND), i.e. the board trace segments are exactly like a regular 1394 cable. It is important to have this connection as short as possible and very well shielded in order to avoid outside interferences affecting signal integrity. Technically, trace segment 215 is only an extension of test bus 250. The total cable length between device A and device B on test bus 250 should not exceed the specified length of 4.5 m. In order to avoid connecting two standard length cables and hence violate the 1394 specification or standard, shortened cables 212 and 213 are connected to connectors 210 and 211. In the embodiment, the connectors are recessed and the cables attached to the external housing of the stealth module 200. The connectors can be exposed and the shortened cables 201 can be used. The exposed portion of trace segment 215 allows for access to data on test bus 250. TPA+/TPA− and TPB+/TPB− are “T” ed off the trace segment 215 and are routed into the stealth module circuitry mainly comprising an analog delay element 220, a direction sensing logic 222, a high speed directional switch 224, and analog line drivers 226.

The function of the direction sensing logic 222 is the identification of the data transmission direction on the test bus 250, i.e. data on TPA+/TPA− and strobe on TPB+/TPB− or vice versa. The direction sensing logic 216 is implemented as high speed state logic circuitry. A combination of analog signal level and time window comparators allows detection of the transmission direction on test bus 250. Variations in determining the transmission direction can achieve similar results.

Direction sensing logic 222 creates an output signal 223,which is used to control directional switch 224. Since the data path is parallel to the direction sensing logic 222, a delay element 220 is used to compensate for the direction sensing logic delay. It buffers and reconditions the incoming packet transmission long enough to compensate for the time duration of packet transmission direction determination. The delay is constant and can be easily compensated later in higher level software specifically for accurate packet arrival time measurement.

In the embodiment, the directional switch 224 is implemented with a multiplexer (MUX). Other hiqh speed switching circuits can be used. The directional switch converts data so that, seen from data analyzer 10, data are always received on TPA+/TPA−, and strobe is received on TPB+/TPB−. Below Table 1 shows a logic table for this relationship.

TABLE 1

| Switch Input | | |
|---|---|---|
| Transmission | | |
| Direction | Control | Switch Out |

| | A→B | B→A | Sense Out | Data Analyzer In |
|---|---|---|---|---|
| Data | TPB¹ | TPA¹ | 0 | TPA² |
| Strobe | TPA¹ | TPB¹ | 1 | TPB² |

¹= observed on Device A
²= observed on Data Analyzer

The output from directional switch 224 is then connected to a set of line drivers 226. Line drivers 226 are implemented as operational amplifiers, which have high input impedances that guarantee that there is no loading effect on the pass through test bus 215. The output impendance needs to be matched to specified 1394 cable 231 impedance. The amplifying circuit 226 is uni-directional only, i.e. signals or data generated on data analyzer 10 will not reach test bus 250. Variations in amplifying data can result in similar performance.

The resulting signals are routed into a regular 1394 bus connector that allows connection of stealth module 200 to the 1394 bus interface 190 of data analyzer 10, and more specifically to the 1394 connector 195. Since this connector can be a 6 pin or a 4 pin connector, the power and ground lines on connector 230 are not used. No power is taken off the 1394 bus interface 195 of the data analyzer 10. Utilizing the power off bus interface 230 is a variation of the invention.

Also, the entire stealth module 200 is powered off a separate power supply module 240. The invention convers power supplied from the 1394 bus interface 190, external power via AC/DC converter or power off test bus 250.

The entire stealth module 200 is operated at very high speeds, since current transmission rates are 400 Mbps and may go up to 3.2 Gbps in the future. At this speed careful consideration to electromagnetic interferences and radio frequency interference emission problems must be given. The effects of these interferences should be minimized using known techniques for designing circuit boards for high speed applications. Generally, it is desirable to keep all trace lengths as short as possible. Adequate ground planes and adjacent ground traces will provide the necessary shielding.

Also, the entire stealth module 200, including all components, traces and connectors, has to match the specified impedance values for a 1394 cable precisely. The physical layer 193 of the 1394 bus interface 190 on data analyzer 10 only has a small window of valid impedance values (±6 ohms).

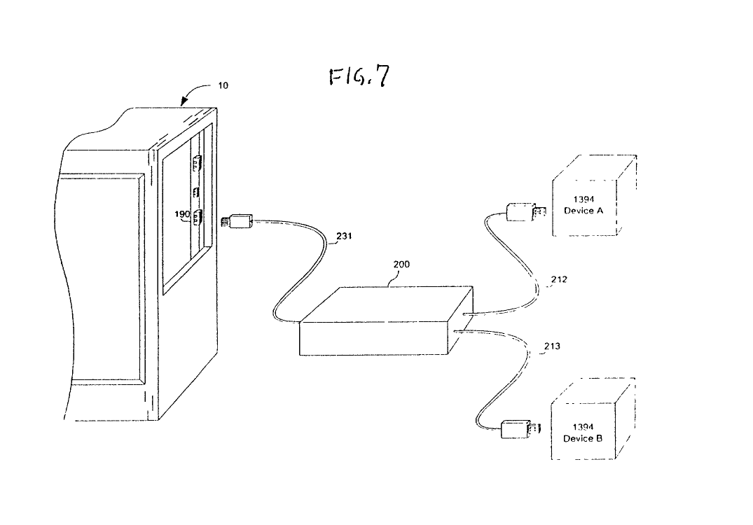

FIG. 7 depicts actual use of the invention, wherein the stealth module is easily connected to the analyzer and the test bus. Standard 1394 cables 231, 212, and 213 allow direct connection into 1394 connectors 195 on data analyzer 10 and to devices A and B. Cables 212 and 213 and trace segment 210 function as one single 1394 cable. Hence, devices A and B form an active 1394 bus. The cables 212 and 213 interconnect the two buses in case other nodes are connected to devices A and B.

Thus, in the invention, a stealth module is used to logically isolate the 1394 bus under test from the data analyzer. By inserting the stealth module, the test bus is not affected by the data analyzer and the amount of power used is not affected. Thus, the stealth module still allows passing transmission data on the test bus over to the 1394 bus interface. Moreover, it provides high speed transmission direction sensing and switching for proper signal reception on the data analyzer. This enables provision of a new generation of testing devices for high speed 1394 serial bus which minimize the effects on the system under test to substantially zero. For the bus under test, the data analyzer is effectively not present. The possible test scenaries enabled by the invention will ease testing requirements for 1394 enabled products. Hence, the invention strengthens product quality, device interoperability, and continued sucess of serial bus technology.

The foregoing description is illustrative of the principles of the invention. Numerous extensions and modifications thereof would be apparent to the worker skilled in the art. All such extensions and modifications are to be considered to be part and parcel of the invention.

What is claimed is:

1. A stealth module for use in a bus analyzer, said module comprising:
a test bus extension; and
a stealth means for isolating said bus analyzer from said test bus extension.

2. The module of claim 1, wherein said test bus extension comprises a cross-over means for data and strobe transmission to implement a portion of a test bus without repeating usage of power therefor.

3. The module of claim 1, wherein said test bus extension comprises cross-over means for data and strobe transmission, and means for connecting power to a bus being tested.

4. The module of claim 2, wherein said test bus extension further comprises cable means in exposed cable connectors for connection of said test bus extension.

5. The module of claim 3, wherein said test bus extension further comprises cable means in exposed cable connectors for connection of said test bus extension.

6. The module of claim 2, wherein said test bus extension further comprises a modified cable attached to a board trace segment to connect said test bus extension.

7. The module of claim 3, wherein said test bus extension further comprises a modified cable attached to a board trace segment to connect said test bus extension.

8. The module of claim 1, wherein said stealth means comprises a unidirectional isolation of said bus analyzer and said test bus extension.

9. The module of claim 8, wherein said stealth means further comprises means for capturing and analyzing data on said test bus extension.

10. The module of claim 8, wherein said stealth means further comprises:
a delay element;
a transaction direction sensing logic;
a high speed directional stitch; and
a set of signal line drivers.

11. The module of claim 10, wherein said delay element comprises at least one analog data buffer.

12. The module of claim 10, wherein said transaction directional sensing logic comprises means for determining data transmission direction on said test bus extension.

13. The module of claim 10, wherein said transaction direction sensing logic comprises means for causing an output signal to release transmission temporarily buffered in said delay element.

14. The module of claim 12, wherein said transaction direction sensing logic comprises means for causing an output signal to indicate data transmission direction on said test bus extension.

15. The module of claim 14, wherein said high speed directional switch comprises means for signal unification.

16. The module of claim 15, wherein said high speed directional switch comprises means for converting bi-directional data and strobe transmission to data and strobe receiving to data.

17. The module of claim 15, wherein said high speed directional switch comprises means for causing triggering of said switch by a directional sensing logic output.

18. The module of claim 10, wherein said set of signal line drivers comprise a least one signal amplifier per signal line.

19. The module of claim 18, wherein said set of signal line drivers comprise input impedance of an amount to avoid loading of said test bus extension.

20. The module of claim 18, wherein said set of signal line drivers comprise an output impedance which matches impedance values of a regular cable.

21. The module of claim 1, further comprising means for supplying power to said module, and comprising means for supplying sufficient power and for conditioning said power.

22. The module of claim 21, wherein said means for supplying power is selected from the group consisting of:
a regular AC power input with sufficient AC/DC conversion;
an external DC power source with suitable connections;
a power conditioning circuit to take power off a test bus;
a power conditioning circuit to take power off a bus analyzer;
and any combination of the foregoing.

23. The module of claim 1, wherein said bus analyzer comprises a bus interface, and further comprising a standard cable for attaching said bus analyzer to said module.

24. The module of claim 23, wherein said bus analyzer comprises a bus interface, and further comprising a modified cable connected directly to said stealth means.

25. The module of claim 23, wherein a separate stealth means is connected to said bus analyzer.

26. The module of claim 23, wherein a separate stealth means is connected to a bus interface on said bus analyzer.

27. A data analysis apparatus comprising:
at least one processor;
a memory coupled to said at least one processor;
a system bus coupled to said at least one processor;
a data analyzer program stored in said memory; and
at least one stealth capable bus interface, said bus interface comprising:
a link layer module comprising a link layer device,
a physical layer module comprising a physical layer device; and
a stealth module for providing isolation of said physical layer and a test bus.

28. The apparatus of claim 27, wherein said stealth module comprises circuit means, and a segment of said test bus comprising two bus connectors or attached cables.

29. The apparatus of claim 27, wherein said stealth module comprises:
a delay element;
a transaction direction sensing logic;
a high speed directional switch; and
a set of signal line drivers.

30. The apparatus of claim 29, wherein said delay element comprises at least one analog data buffer.

31. The apparatus of claim 29,wherein said transaction direction sensing logic comprises means for determining data transmission direction on said test bus.

32. The apparatus of claim 29, wherein said transaction direction sensing logic comprises means for causing an output signal to release transmission temporarily buffered in said delay element.

33. The apparatus of claim 29, wherein said transaction direction sensing logic comprises means for causing an output signal to indicate data transmission direction on said test bus.

34. The apparatus of claim 29, wherein said high speed directional switch comprises means for signal unification.

35. The apparatus of claim 29, wherein said high speed directional switch comprises means for converting bi-directional data and strobe transmission to data, and for converting strobe receive to data.

36. The apparatus of claim 29, wherein said high speed directional switch comprises means for triggering said switch by a directional sensing logic output.

37. The apparatus of claim 29, wherein said set of signal line drivers comprise at least one signal amplifier per signal line.

38. The apparatus of claim 29, wherein said set of signal line drivers comprise sufficient input impedance to avoid loading said test bus.

39. The apparatus of claim 29, wherein said set of signal line drivers comprise output impedance which match impedance value of a regular cable.

40. The apparatus of claim 29, wherein said set of signal line drivers comprise means for directly connecting output of said drivers to a physical layer port.
